(19) United States
(12) Patent Application Publication
(10) Pub. No.: US 2023/0032935 A1
(43) Pub. Date: Feb. 2, 2023

(54) DIRECTING AIR STREAMS AT A TARGET

(71) Applicant: iRobot Corporation, Bedford, MA (US)

(72) Inventors: Pierre Bi, Wilen b Wollerau (CH); Thomas Bi, Seuzach (CH); Etienne Bougeot, Baar, (CH); Constantin Overlack, Kilchberg (CH); Duarte Santos, Rotkreuz (CH)

(21) Appl. No.: 17/874,553

(22) Filed: Jul. 27, 2022

Related U.S. Application Data
(60) Provisional application No. 63/227,839, filed on Jul. 30, 2021.

(51) Int. Cl. F04D 25/10; F04D 19/00; F04D 27/00; F04D 29/52; F04D 29/66; F04D 29/70

(52) U.S. Cl. CPC F04D 25/105; F04D 19/002; F04D 27/004; F04D 27/008; F04D 29/522; F04D 29/667; F04D 29/703

(57) ABSTRACT

A method of a fan system directing an air stream at a target can include receiving, with a controller, a first image from an image capture sensor and analyzing the first image from the image capture sensor to determine a first location of the target. The method can also include receiving a second image from the image capture sensor and analyzing the second image from the image capture sensor to determine a second location of the target. The method can also include comparing the first location of the target and the second location of the target and sending a signal to a first motor to rotate a housing about a first axis respective to a base to direct an air stream exiting an outlet of a channel at the target.

### CLAIM OF PRIORITY

This patent application claims the benefit of priority, under 35 U.S.C. Section 119(e), to Pierre Bi U.S. Patent Application Ser. No. 63/227,839, entitled “SYSTEM AND METHOD TO CREATE OBJECT OR PERSON ORIENTED DIRECTED AIR STREAMS” filed on Jul. 30, 2021, which is hereby incorporated by reference herein in its entirety.

### BACKGROUND

Air moving machines (e.g., fans, air makeup, heaters, or any other form of air moving machine) move air throughout a room or an environment. Air movement can be necessary to cool, heat, purify, humidify, or dehumidify an environment. Air moving machines can be used for personal and commercial purposes. For example, a person can use an air moving machine to cool a room on a hot day or to heat a room on a cool day. In another example, commercial uses of air moving machines can include controlling the environment in which they manufacture products. For example, a welding shop can have an air makeup machine to improve the air quality within the room.

Providing clean air can help people live healthier lives. Air purification systems can clean air and distribute the clean air throughout an environment. Certain tasks (e.g., cooking, painting, cleaning) can require more air purification capacity to help protect a person from contaminants (e.g., smoke, fumes, dust, allergens, viruses, aerosols, or any other air contaminants).

### SUMMARY

The inventors recognize a need to produce an airflow that will track a user as a user moves in an environment. The tracking can be performed with an image device sensor that communicates with a controller that can adjust the orientation and speed of the fan based on the position of the target. The airflow, or air stream, can be filtered such that a clean air stream is provided to the target. Health and wellness are becoming increasingly important within society. One area of health that has gained a lot of traction over the past few years is lung health. Lung health is one of many factors (e.g., mental health, nutrition, exercise, or sleep) that can improve the quality of life of a person. Unfortunately, a person can be exposed to many contaminants (e.g., pollution, dust, allergens, viruses, or any other impurities, debris, or aerosols in the air breathed in by the person) throughout the day. These contaminants can cause adverse health issues (e.g., allergies, asthma, viral and bacterial infections of the respiratory system, or any other ailment from contaminants in the air).

A system and methods to improve the air quality inhaled by a person completing everyday tasks can help improve the person's health. For example, a fan system can include a controller that can communicate with motors to adjust the direction of an air stream leaving an outlet of the fan system, or to change the velocity of an air stream flowing through the fan system. The fan system can include a sensor (e.g., an image capturing sensor, air quality sensor, a microphone, a position sensor, or any other sensor to detect information about an environment around the fan system). More specifically, a target can be selected, and the sensor can capture information (e.g., the location, the body temperature, the respiratory rate, the activity engaged in by the target, or any information that can be captured by an image sensor or a perceptive sensor) about the target within the environment. The controller can receive the information captured by the sensors and analyze (e.g., process, compare, or evaluate) the information captured by the sensors to change one or more operations (e.g., orientation, fan speed, or any other operation of a fan system) of the fan system.

In an example, a method of a fan system directing an air stream at a target can include receiving, with a controller, a first image from an image capture sensor and analyzing the first image from the image capture sensor to determine a first location of the target. The method can also include receiving a second image from the image capture sensor and analyzing the second image from the image capture sensor to determine a second location of the target. The method can also include comparing the first location of the target and the second location of the target and sending a signal to a first motor to rotate a housing about a first axis respective to a base to direct an air stream exiting an outlet of a channel at the target.

In another example, a fan system for directing an air stream at a target includes a base that can be configured to rest on a surface of an environment and an arm that can include a first portion rotatably connected to the base and a second portion opposite the first portion. The fan system can also include a housing rotatably attached to the second portion of the arm. The housing can define a channel extending between an inlet and an outlet. A first motor can be connected to the first portion of the arm and the base and can be operable to rotate the arm and the housing about a first axis relative to the base. A second motor can be connected to the second portion and the housing and can be operable to rotate the housing about a second axis relative to the base. A fan can be located within the housing between the inlet and the outlet of the channel. The fan can be operable to generate an air stream to flow through the channel from the inlet to the outlet. An image capture sensor can be connected to the housing and can be configured to produce an image capture signal based on images of the environment. The fan system can also include a controller that can be in communication with the first motor, the second motor, the fan, and the image capture sensor. The controller can be configured to control the fan, the first motor, and the second motor based on the image capture signal.

In yet another example, a fan system for directing an air stream at a target can include a base that can be configured to rest on a surface of an environment. The fan system can also include an arm including a first portion that can be rotatably connected to the base and a second portion opposite the first portion. A housing can be rotatably attached to the second portion of the arm. The housing can define a channel extending between an inlet and an outlet. A first motor can be connected to the first portion of the arm and the base and can be operable to rotate the arm and the housing about a first axis relative to the base. A fan can be located within the housing between the inlet and the outlet of the channel. The fan can be operable to generate an air stream to flow through the channel from the inlet to the outlet. The fan system can also include a sensor that can be connected to the housing and can be configured to produce a signal based on the environment. A controller can be in communication with the first motor, the fan, and the sensor. The controller can be configured to control the fan and the first motor based on the signal.

### BRIEF DESCRIPTION OF THE DRAWINGS

The patent or application file CONTAINS AT LEAST ONE DRAWING EXECUTED IN COLOR. Copies of this patent or patent application publication with color drawing(s) will be provided by the Office upon request and payment of the necessary fee.

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a schematic diagram of an example of a fan system directing an air stream at a target.

FIG. 2 is a perspective view of an example of a fan system.

FIG. 3 is another perspective view of an example of a fan system.

FIG. 4 is an exploded view of an example of a portion of a fan system.

FIG. 5 is a perspective view of an example of a fan of a fan system.

FIG. 6 is a cross-sectional view of an example of a fan system.

FIG. 7 is a perspective view of an example of a nozzle of a fan system.

FIG. 8 is a cross-sectional view of an example of a nozzle of a fan system.

FIG. 9 illustrates an example of computational fluid dynamics (CFD) analysis of an air stream through an example of a fan system.

FIG. 10 is a perspective view of a portion of a fan system showing an example of an image sensor.

FIG. 11 is a schematic diagram of an example of the fan system.

FIG. 12 illustrates an example of a fan system tracking a target in an environment.

FIG. 13 illustrates an example of a fan system tracking a target in an environment.

FIG. 14 illustrates an example of a fan system analyzing an activity of a target.

FIG. 15 illustrates an example of a fan system analyzing an activity of a target.

FIG. 16 illustrates an example of a fan system adjusting a clean air bubble as a target moves in different directions.

FIG. 17 illustrates an example of a fan system adjusting a direction of an air stream around an object obstructing the air stream.

FIG. 18 is a schematic diagram showing data transfer between an example of a fan system, user devices, and servers.

FIG. 19 illustrates a flow diagram of an example of a method for directing an air stream at a target.

FIG. 20 is a block diagram illustrating an example of a fan system upon which one or more embodiments can be implemented.

### DETAILED DESCRIPTION

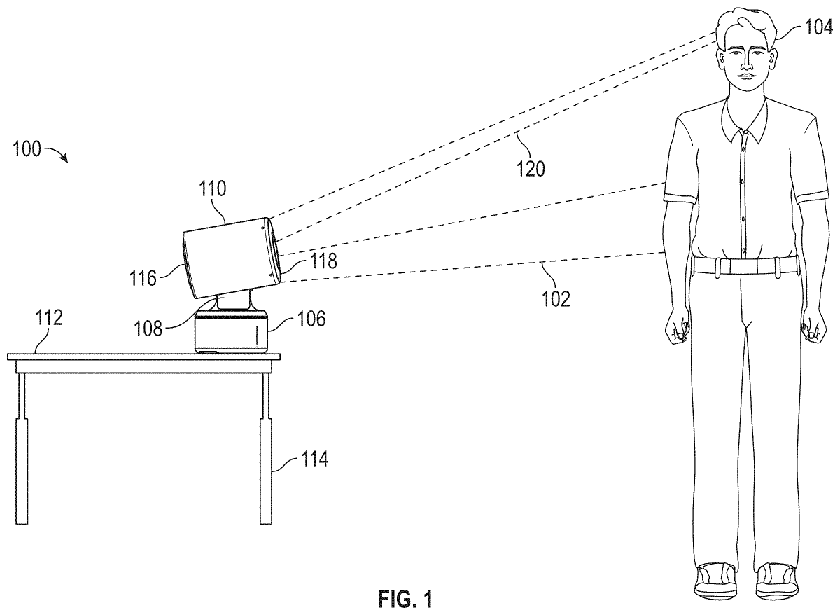

FIG. 1 is a schematic diagram of an example of a fan system 100 for directing an air stream 102 at a target 104. As shown in FIG. 1, the fan system 100 can include a base 106, an arm 108, and a housing 110.

The target 104 can be an animate object (e.g., a person, plant, or other living organism) or an inanimate object (e.g., furniture, a fixture, a specified location, or any other inanimate object), or anything else that a user desires to cool, monitor, or provide clean air. In examples, the target 104 can be selected by a user in an application that communicates with the fan system 100. In another example, the target 104 can be selected from the user manually manipulating the direction that the fan system 100 is directing the air stream 102. In yet another example, the target 104 can be generally, a room, as the fan system 100 is set to an oscillation mode that can oscillate the arm 108 and the housing 110 with respect to the base 106 and oscillate the housing 110 with respect to the arm 108. Each of these described oscillations can be independently controlled.

The base 106 can be configured to rest on a surface. For example, as shown in FIG. 1, the base 106 can be configured to rest on a top surface 112 of a table 114. In the example shown in FIG. 1, the base 106 can be generally cylindrical, and in another example, the base 106 can be any other shape, for example, square, rectangular, triangular, or any other shape that can support the fan system 100. In yet another example, the base 106 can have legs, pillars, or any other support that can help the base 106 stabilize on uneven surfaces. The base 106 can act as a case or cover for internal components of the fan system 100, for example, one or more motors, controllers, batteries, antennas, or other electrical or mechanical components of the fan system 100. Thus, the base 106 can be made from a metal, plastic, composite material, or a combination thereof, that protects the components within the base 106.

The arm 108 can be configured to extend from the base 106 to provide the housing 110 clearance to move during the operation of the fan system 100. The arm 108 can include internal components that help support the housing 110 above the base 106. In examples, the arm 108 can include wires that help devices within the housing 110 communicate with devices within the base 106. The arm 108 can be any shape that provides clearance between the base 106 and the housing 110, can support the weight of the housing 110, and permit the movement of the housing 110.

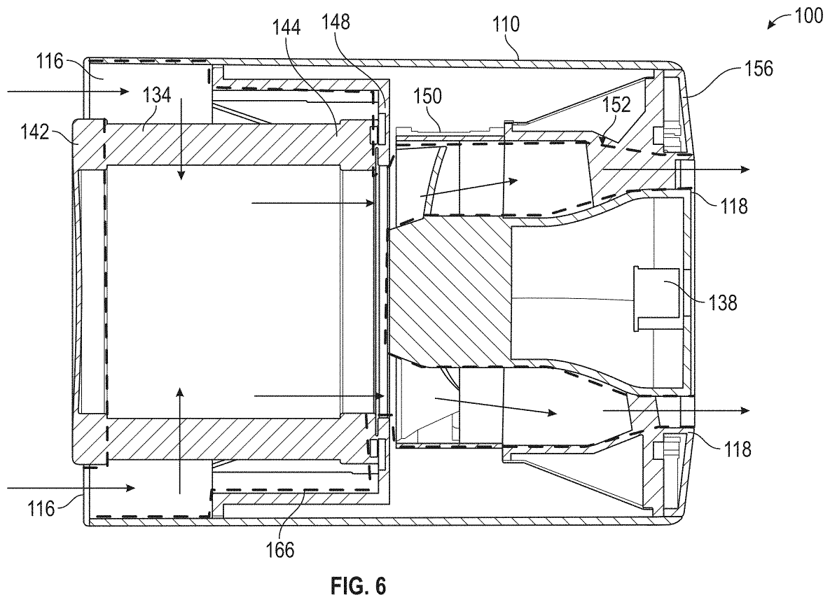

The housing 110 can be configured to support internal components (e.g., a filter, a fan, a nozzle, etc.) of the fan system 100 and direct the air stream 102 through the fan system 100. The housing 110 can be rotatably attached to the arm 108, Moreover, the housing 110 can define a channel (first shown in FIG. 6) extending between an inlet 116 and an outlet 118. The air stream 102 can be directed out of the outlet 118 by the housing 110 and the nozzle (discussed in more detail with reference to FIGS. 6-8). A sensor or an image capture sensor (not shown in FIG. 1) can be installed at the outlet 118 and can determine a field of view 120 of the fan system 100. The field of view 120 shown in FIG. 1 is only shown for illustrative purposes and is not intended to be limiting in any way. In some examples, the field of view 120 of the fan system 100 can be wider than the air stream 102 of the fan system 100.

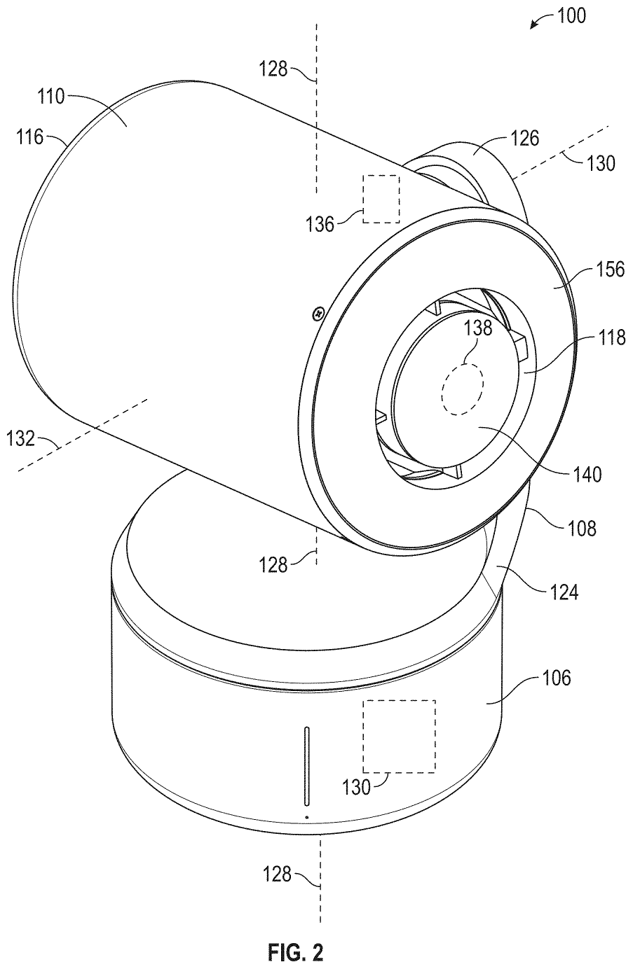

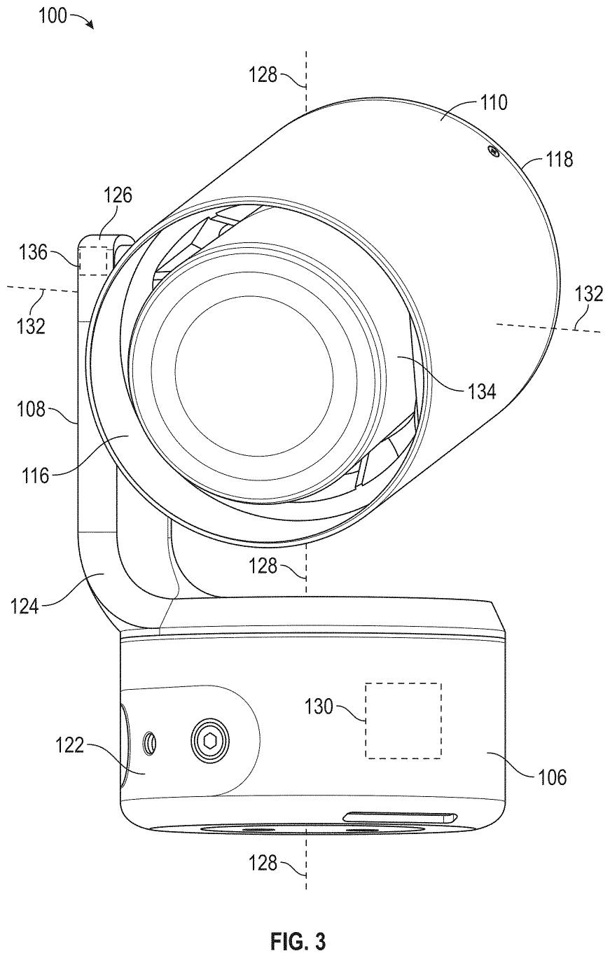

The details of the fan system 100, the base 106, the arm 108, and the housing 110 will be discussed in more detail below with reference to FIGS. 2 and 3.

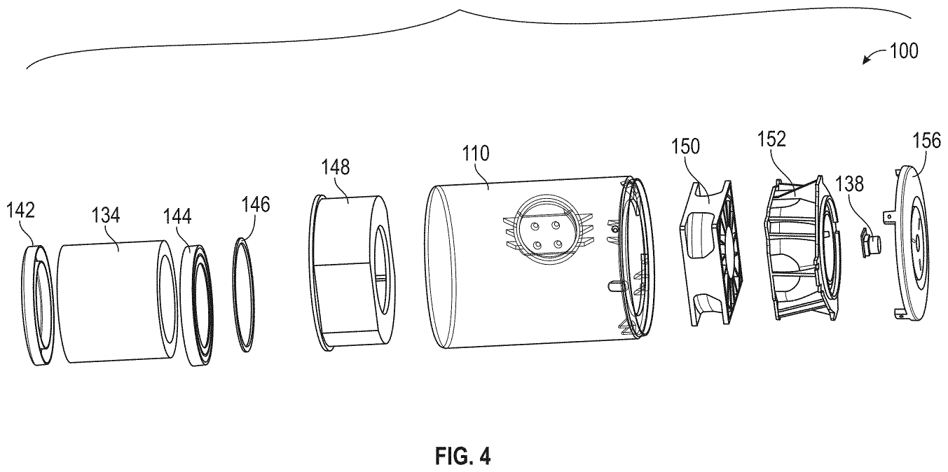

In operation of some examples, the fan system 100 can be configured to supply clean air for the target 104. Here, the fan system 100 can turn on a fan (first shown in FIG. 4) to direct an air stream through the fan system 100. The air stream will flow into the fan system 100 through the inlet 116 and out of the fan system 100 through the outlet 118. In examples, the fan system 100 can include a filter (first shown in FIG. 3) that can filter the air stream as the fan draws the air stream into the housing 110 through the inlet 116. The fan can pull the air from the filter and through the fan. The air stream can leave the fan and flow into a nozzle (first shown in FIG. 4). In the nozzle, the air stream can be accelerated by the nozzle as the air stream flows towards the outlet 118. The air stream can flow through an end plate (first shown in FIG. 2) and exit the fan system 100. In examples, the air stream can have a greater velocity as it flows out of the outlet 118 than the air stream did when it flowed into the inlet 116. Because of the increased velocity, the air stream that exits the outlet 118 can reach the target 104. Thus, the fan system 100 can provide clean air for the target 104.

FIGS. 2 and 3 are discussed together below. FIG. 2 is a perspective view of an example of the fan system 100. FIG. 3 is another perspective view of an example of the fan system 100. As best shown in FIG. 3, the base 106 can include a user interface 122. The user interface 122 can include various buttons or controls for an operator to directly control the fan system 100. In examples, the user interface 122 can output information (e.g., a room temperature, a measurement of contaminants in the room, or an indication of a program being run by the fan system 100) to the user.

As shown in FIGS. 2 and 3, the arm 108 can include a first portion 124 attached to the base 106. In examples, the first portion 124 can be rotatably attached to the base 106. For example, the arm 108 can rotate around a first axis 128 relative the base 106. The base 106 can include a motor 130 that is configured to rotate the arm 108 and the housing 110 around the first axis 128 relative to the base 106. The motor 130 can be in electrical or wireless communication with one or more controllers that send signals to the motor 130 to control the direction and speed of rotation of the motor 130. In some examples, the motor 130 can be operable to rotate the arm 108 and the housing 110 completely around the first axis 128. In another example, motor 130 can limit the rotation of the arm 108 and the housing 110 around the first axis 128. Here, the motor 130, can limit rotation to 240 degrees or less around the first axis 128.

The arm 108 can include a second portion 126. The housing 110 can be rotatably attached to the second portion 126 of the arm 108. For example, the housing 110 can rotate about a second axis 132 relative to the arm 108. A second motor 136 can be installed within the second portion 126 of the arm 108, or within the housing 110. The second motor 136 can be in electrical or wireless communication with one or more controllers that send signals to the second motor 136 to control the direction and speed of rotation of the second motor 136. In some examples, the second motor 136 can be operable to rotate the housing 110 completely around the second axis 132. In another example, the second motor 136 can limit the rotation of the housing 110 around the second axis 132. Here, the second motor 136 can limit rotation to 240 degrees or less around the second axis 132. In examples, the motors (e.g., the motor 130 and the second motor 136) can be electronic stepper, stepless, gimbal, direct drive, linear, or any other variety of other types of electronic linear/axial motors.

As shown in FIG. 3, the fan system 100 can include a air filter 134. The air filter 134 can be a radial filter that can be attached within the housing 110 near the inlet 116. The air filter 134 being a radial filter can help to decrease a pressure drop through the inlet 116 and across the air filter 134, which can decrease the strain on the fan of the fan system 100 and can increase the efficiency of the fan system 100. In examples, the air filter 134 can be a high efficient particulate absorbing (HEPA) filter. In another example the air filter 134 can be an ultra-low particulate air filter. In yet another example, the air filter 134 can be an electrostatic, ultraviolet light, media, pleated, spun glass, or any other kind of filter used in air purification.

As shown in FIG. 3, the inlet 116 can be ring-shaped and the housing 110 can define the shape of the inlet 116. The inlet 116 can have a relatively large cross-sectional area. The large cross-sectional area of the inlet 116 can decrease a resistance to the flow of an air stream into the inlet 116. Thus, the large cross-sectional area of the inlet 116 can decrease the pressure drop through the air system 100.

As shown in FIG. 2, the outlet 118 can be ring-shaped and an end cap 156 can, at least in part, define the shape of the outlet 118. The outlet 118 can have a cross-sectional area less than the cross-sectional area of the inlet 116. The decreased cross-sectional area of the outlet 118 can result in a higher velocity of air leaving the outlet 118 than the air entering the inlet 116. The airflow through the housing 110 will be discussed in more detail below with reference to FIGS. 4-9.

The fan system 100 can also include a sensor 138 that can be located within the ring of the outlet 118 and can be located out of the air stream exiting from the outlet 118. The fan system 100 can also include a sensor cover 140. The sensor cover 140 can help to protect the sensor 138 and allow the perceptive signals (sonar, radar, lidar, image capture, or any other signal that can be sent from a perceptive sensor), For example, the sensor 138 can be a digital camera that can produce greyscale or colored image streams based on imagery of the surrounding environment from all or most perspectives that the fan system 100 can cover. The sensor 138 can stream the image data in any of a variety of forms, for example, analog, USB protocol, GigE Vision, CarneraLink, USB3 Vision, CarneraLink HS, CXP-6, CXP-6 x4, CXP-12 x4, or CSI-2, to a processing unit or controller of the fan system 100.

In an operable example, the fan system 100 can use the sensor 138 to detect a location of a target and direct an air stream at the target (first shown in FIG. 1). In examples, the sensor 138 can capture imagery of the environment around the fan system 100. The fan system 100 can use the captured imagery to control the fan system 100 and direct the air stream of the fan system 100 to a moving target. Moreover, the fan system 100 can use the captured imagery to analyze the activities of the target 104.

FIG. 4 is an exploded view of an example of a portion of the fan system 100. The fan system 100 can include an air block 142, an attachment mechanism 144, an O-ring 146, a filter seat 148, a fan 150, and a nozzle 152,

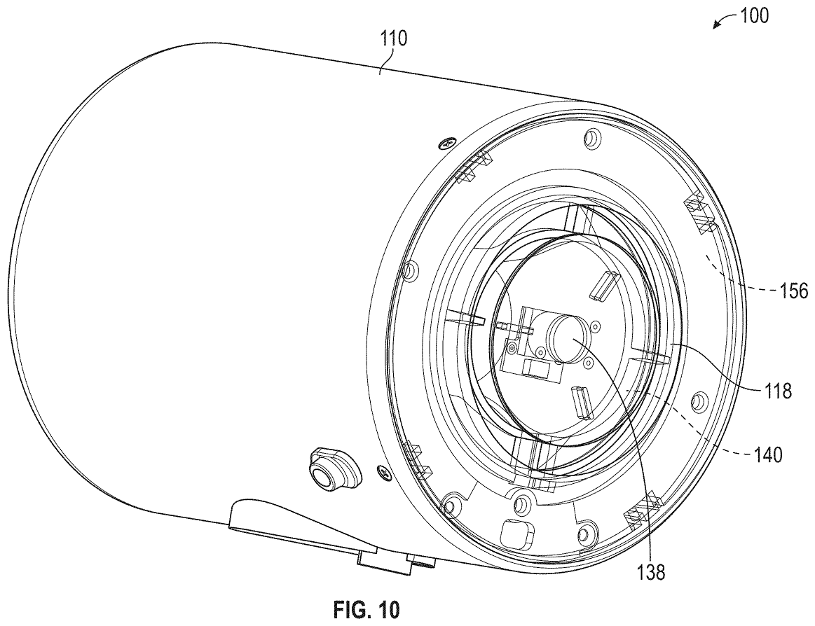

As shown in FIG. 4, the sensor 138 can be installed within the housing 110 between the nozzle 152 and the end cap 156. The sensor 138 will be discussed in more detail below with reference to FIG. 10.

The air block 142 can be configured to help ensure air flows into the inlet 116 (FIG. 3) and through the air filter 134 by limiting air from going through the middle of the air filter 134 without going radially inward through the air filter 134. The air block 142 can be made from metal, plastic, any non-porous composite, or any combination thereof. In another example, the air block 142 can be integral to the air filter 134. In examples, the air block 142 can be removably coupled to the air filter 134. Here, the air block 142 can be magnetically coupled to the air filter 134. In examples, the air filter 134 can be removed from the housing 110 without removing the air block 142.

The attachment mechanism 144 can attach to the air filter 134 and is configured to attach the air filter 134 to the fan system 100. In examples, the attachment mechanism 144 for the air filter 134 can include magnets that are configured to removably attach to the fan system 100 within the housing 110. Here, the attachment mechanism 144 can attach to the filter seat 148 within the housing 110. In another example, the attachment mechanism 144 can include a threaded surface that can be configured to be threaded into a threaded surface within the housing 110. Here, the filter seat 148 can include a threaded surface configured to receive the threaded surface of the attachment mechanism 144 to attach the air filter 134 to the filter seat 148 within the housing 110. In examples, the air filter 134, the air block 142, and the attachment mechanism 144 can be removed from the fan system 100 without removing any other components of the fan system 100. This can allow the 134, the air block 142, and the attachment mechanism 144 to be easily removed by a user, such as for replacement of the air filter 134.

As shown in the example of FIG. 4, the O-ring 146 can be installed between the attachment mechanism 144 and the filter seat 148. In another example, the fan system 100 can also include the O-ring 146 between the filter seat 148 and the fan 150, between the fan 150 and the nozzle 152, and between the nozzle 152 and the end cap 156. The O-ring 146 can be configured to help seal the air within the fan system 100 to prevent air loss throughout the fan system 100. Moreover, the O-ring 146 can help maintain the purification of the air by preventing contaminants from entering the air stream after the air stream has been through the air filter 134.

The filter seat 148 can be configured to receive the air filter 134 and attach to the fan 150 within the housing 110. Here, the filter seat 148 can be located between the attachment mechanism 144 and the fan 150. The filter seat 148 can define an aperture or a hole that matches the size of an outlet of the air filter 134. The hole in the filter seat 148 can once again help to reduce bypass around the air filter 134. In examples, the filter seat 148 can be removably coupled to the housing 110. In other examples, the filter seat 148 can be integral to the housing 110. The filter seat 148 can be metallic, plastic, a non-porous composite, or any combination thereof.

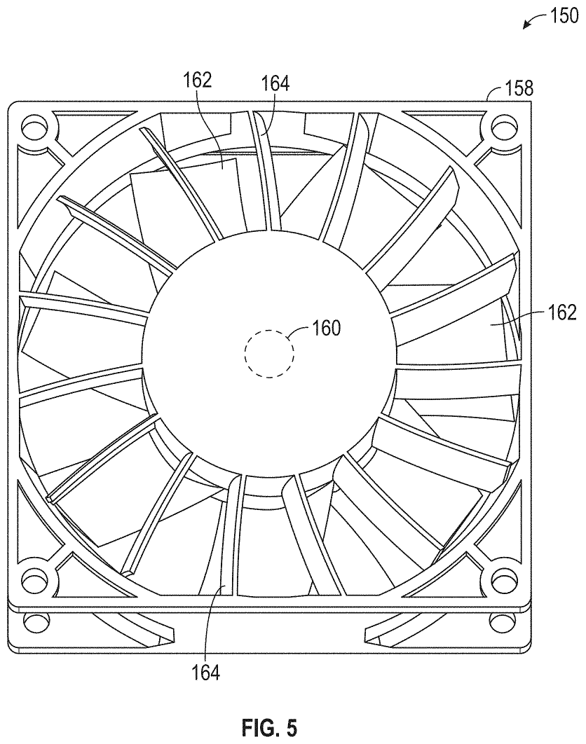

The fan 150 can be configured to move the air through the fan system 100. The fan 150 can be installed within the fan system 100 between the fitter seat 148 and the nozzle 152. The fan 150 can be an axially type or a centrifugally type and and can include any of a variety of types of rotational motor technologies, e.g., fans, blowers, alternating current (AC), direct current (DC), electronically commutated (EC), or smart motors. The fan 150 will be discussed in more detail below with reference to FIGS. 5 and 6.

The nozzle 152 can define at least a portion of the channel and can be configured to increase the velocity of the air stream within the fan system 100 before the air stream reaches the outlet 118. The nozzle 152 can be installed in the fan system 100 between the fan 150 and the sensor 138. The nozzle 152 will be discussed in more detail below with reference to FIGS. 6-9.

As shown in FIG. 4, the end cap 156 can define the outlet 118. In examples, the end cap 156 can be configured to receive the sensor 138 such as to support the sensor 138 therein or thereon. Here, the sensor 138 can be removably mounted to the end cap 156 via screws, bolts, or any other kind of fasteners. In another example, the end cap 156 can include an attachment engagement that interacts with and attaches the sensor 138 to the end cap 156. The attachment engagement can be any sort of slot, latch, clip, or any other way to attach a sensor to a body. In yet another example, the sensor 138 can be integral to the end cap 156. In examples, the end cap 156 can have a hole or aperture at the center of the end cap 156 such that the sensor 138 can detect objects through the hole in the end cap 156. The end cap 156 can be configured to receive the sensor cover 140. In examples, the sensor cover 140 can be permanently affixed (e.g., adhered) to the end cap 156. In another example, the sensor cover 140 can be removably attached (e.g., by magnets, threads, clips, or any other removable attachment mechanism) to the end cap 156.

FIG. 5 is a perspective view of an example of the fan 150 of the fan system 100. The fan 150 can be located within the housing 110 between the inlet 116 (first shown in FIG. 1) and the outlet 118 (first shown in FIG. 1) of the channel. The fan 150 can be operable to generate an air stream to flow through the channel from the inlet 116 to the outlet 118. The fan 150 can include a fan housing 158, a motor 160, airfoils 162, and airflow straighteners 164.

The fan housing 158 can be configured to support the fan 150 within the housing 110 of the fan system 100. The fan housing 158 can surround the airfoils 162 and the airflow straighteners 164. The fan housing 158 can be designed to limit the air stream from bypassing the airfoils 162 of the fan 150. The fan housing 158 can be removably attached (e.g., bolted, screwed into, or clipped into the housing 110 of the fan system 100. The fan housing 158 can be used from any metallic, polymer, composite, or any combination thereof.

The motor 160 can be configured to operably rotate the airfoils 162 within the fan housing 158. The motor 160 can be in communication with a controller of the fan system 100, For example, the controller can control the direction and speed that the motor 160 operates to rotate the 162. In one example, the motor 160 can be an electric motor. In another example, the motor 160 can be an electro-magnetic motor or any other small motor that can be used to operate a fan. In examples, the motor 160 can be a variable speed motor, that has set speeds at which the fan can operate within. In another example, fan system 100 can include an inverter to control the speed of the motor 160 to maintain a desired pressure through the fan system 100.

The airfoils 162 can be configured to direct an air stream through the fan system 100 when the airfoils 162 are rotated by the motor 160. The airfoils 162 can have different geometries (e.g., thickness, bow, twist, stagger, dihedral angle, camber, chord, or any other airfoil geometry) to accommodate different air curves through the fan system 100. As shown in FIG. 5, the airfoils 162 can connect to and extend radially from a hub and can be only supported from the hub. In another example, the airfoils 162 can span between a hub and a peripheral ring. Optionally, the peripheral ring can connect each of the airfoils 162 to provide support for each of the airfoils 162 toward the tip of the airfoils 162. The airfoils 162 can be made from metals, plastics, composites, or any combination thereof.

The airflow straighteners 164 can be configured to straighten or redirect the air stream out of the fan 150 toward the outlet 118 of the housing 110. In examples, the airflow straighteners 164 can be stator blades. The airflow straighteners 164 can have different geometries (e.g., thickness, bow, twist, stagger, dihedral angle, camber, chord, or any other airfoil geometry). Any of the geometries can be altered to decrease loss and improve the efficiency of the air stream flowing through the fan system 100. In an example, the airflow straighteners 164 can be shaped to minimize the Reynolds number of the air stream exiting the fan 150. Reducing the Reynolds number can help reduce the turbulent flow and decrease eddy currents in the air stream exiting the fan 150. Minimizing the turbulent flow and decreasing the eddy currents can help to reduce the losses as the air stream exits the fan 150 and enters the nozzle 152.

FIG. 6 is a cross-sectional view of a section of an example of the fan system 100. Specifically, FIG. 6 illustrates how an air stream flows from the inlet 116 to the outlet 118 of a channel 166.

The air stream can enter the channel 166 through the inlet 116. As shown in FIG. 6, the channel 166 between the inlet 116 and the air filter 134 can be defined by the housing 110. The channel 166 can then extend radially inward through the air filter 134. The channel 166 can then be at least partially defined between the air filter 134 and the fan 150 by the filter seat 148. As discussed above, the filter seat 148 can define a hole that directs the air stream from the air filter 134 into the fan 150. The portion of the channel 166 within the fan 150 can be defined by the hub of the fan 150 and the fan housing 158 of the fan 150. From the fan 150, the channel 166 can be defined by the nozzle 152. The channel 166 can extend through the nozzle 152 and out the end cap 156. In examples, the end cap 156 can shape the outlet 118.

As shown in FIG. 6, the channel 166 can have varying cross-sectional areas as the channel 166 progresses through the housing 110. For example, toward the inlet 116, the channel 166 can have a larger cross-sectional area than the 166 at the outlet 118. The large cross-sectional area of the channel 166 on the inlet 116 side of the fan 150, when compared to the outlet 118 side of the fan 150, can reduce a pressure loss into the channel 166 and across the air filter 134. In examples, the most significant change to the cross-sectional area of the channel 166 can occur within the nozzle 152.

In an operable example of the fan system 100, the channel 166 can extend from the inlet 116 to the outlet 118. In examples, the channel 166 can direct airflow through the fan system 100. As the channel 166 extends through the fan system 100), the channel 166 can have variances in a cross-sectional area. For example, a decrease in cross-sectional area in the channel 166 can increase the velocity of the air flowing through the channel 166. In contrast, an increase in cross-sectional area of the channel 166 can decrease the velocity of the air flowing through the channel 166.

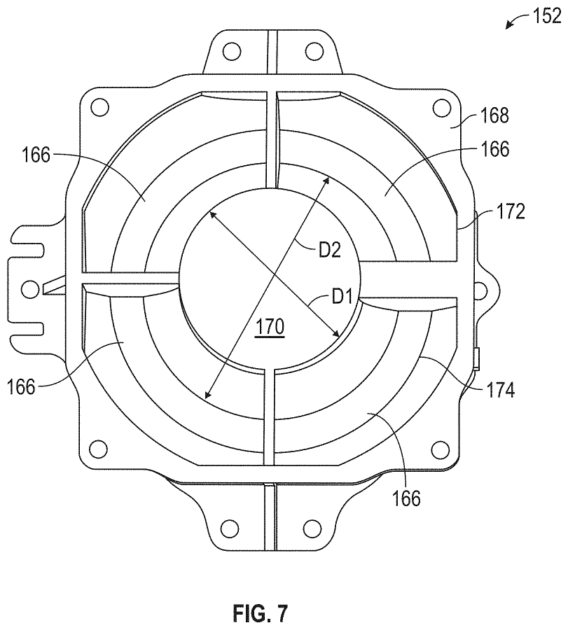

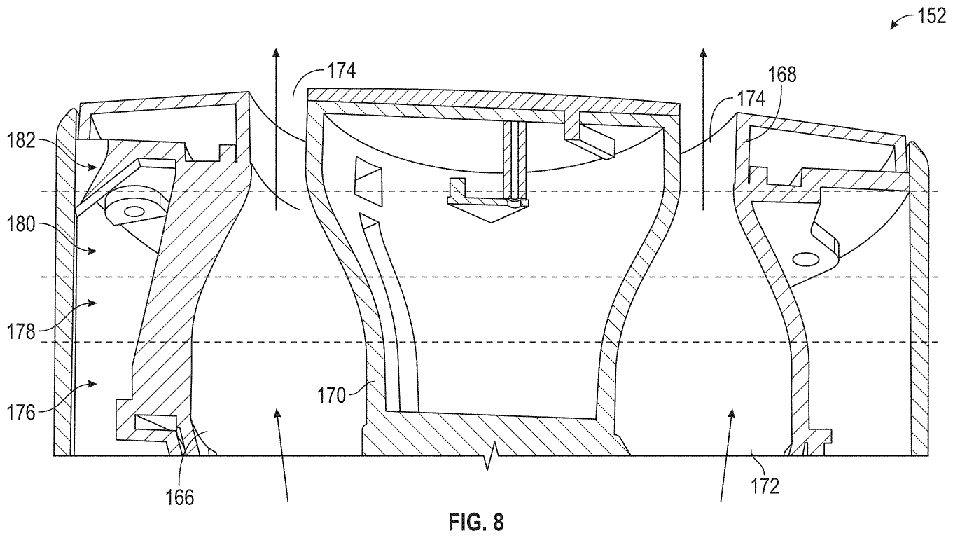

The channel 166 within the nozzle 152 will be discussed below with reference to FIGS. 7 and 8. FIG. 7 is a perspective view of an example of the nozzle 152 of a fan system 100. FIG. 8 is a cross-sectional view of an example of a nozzle 152 of a fan system 100. As shown in FIGS. 7 and 8, the nozzle 152 can include a casing 168. a hub 170, an inlet 172, and an outlet 174.

The casing 168 can be configured to define an outer portion of the nozzle 152. The casing 168 can be sized to fit within the housing 110 of the fan system 100. The casing 168 can include one or more bores, tabs, or braces to help attach the nozzle 152 to the housing 110. The casing 168, in combination with the hub 170, can define the channel 166 within the nozzle 152. Thus, the cross-sectional area of the channel 166 within the nozzle 152 can be a distance between an inner wall or surface of the casing 168 and an outer wall or surface of the hub 170.

The hub 170 can extend from the inlet 172 to the outlet 174. As shown in FIGS. 7 and 8, the hub 170 can have a smaller diameter D1 at the inlet 172 than a diameter D2 at the outlet 174. As a result of the smaller diameter of the hub 170 at the inlet 172, the channel 166 can have a larger cross-sectional area at the inlet 172 than at the outlet 174. The hub 170 can have a varying rate of change while extending from the inlet 172 to the outlet 174. For example, the rate of change can increase as the hub 170 nears the outlet 174. In another example, the hub 170 can have the greatest rate of change nearest the inlet 172. In yet another example, the hub 170 can have a constantly varying rate of change as the hub 170 extends from the inlet 172 to the outlet 174.

As shown in the example of FIG. 8, the channel 166 can have multiple sections of varying cross-sectional area throughout the nozzle 152. For example, the channel 166 can have a first section 176, a second section 178, a third section 180, and a fourth section 182. The first section 176 can extend between the inlet 172 and the second section 178. The second section 178 can extend between the second section 178 can extend between the first section 176 and the third section 180. The third section 180 can extend between the second section 178 and the fourth section 182. The fourth section 182 can extend between the third section 180 and the outlet 174.

The first section 176 can have the largest cross-sectional area of the sections 176-182. Moreover, the first section 176 can have the lowest rate of change of cross-sectional area of each of the first section 176, the second section 178. the third section 180, and the fourth section 182. Because of the first section 176 having the largest cross-sectional area, and the lowest rate of change in cross-sectional area, the first section 176 can have the lowest velocity of the air stream within the nozzle 152. In examples, the channel 166 within the first section 176 can include smooth surfaces to further limit turbulence and reduce the Reynolds number of the air stream through the nozzle 152.

As shown in FIG. 8, in the second section 178 the hub 170 can extend radially outward toward the casing 168. Thus, the second section 178 can have a cross-sectional area less than the first section 176. Moreover, the second section 178 can have a low rate of change of the cross-sectional area to help reduce Reynolds number of the air stream flowing through the second section 178. Because the second section 178 has a cross-sectional area less than the cross-sectional area of the first section 176, the air stream can have a higher velocity while flowing through the second section 178 than the air stream flowing through the first section 176. In examples, the channel 166 within the second section 178 can include smooth surfaces to further limit turbulence and reduce the Reynolds number of the air stream through the nozzle 152.

As shown in FIG. 8, in the third section 180 the hub 170 can extend radially outward toward the casing 168 and the casing 168 can extend radially inward toward the hub 170. Thus, the third section 180 can have a cross-sectional area less than the first section 176 and the second section 178. The hub 170 extending radially outward and the casing 168 extending radially inward can result in the third section 180 having a greater change in cross-sectional area than the first section 176 and the second section 178. Because the third section 180 can have a cross-sectional area less than the first section 176 and the second section 178, the air stream can have a higher velocity while flowing through the third section 180 as compared to the air stream flowing through the first section 176 and the second section 178. In examples, the channel 166 within the third section 180 can include smooth surfaces to further limit turbulence and reduce the Reynolds number of the air stream through the nozzle 152.

As shown in FIG. 8, the fourth section 182 can have the smallest cross-sectional area of the nozzle 152. In examples, the fourth section 182 can have a lower rate of change in cross-sectional area than the second section 178 and the third section 180. Optionally, the fourth section 182 can have no change such as to straighten the airstream at a discharge of the nozzle to help reduce turbulence of the air stream to the target. For example, as shown in FIG. 8, the casing 168 and the hub 170 can be substantially parallel within the fourth section 182 to reduce pressure drop through the fourth section 182 and increase the velocity of an air stream flowing through the fourth section 182. Thus, because the fourth section 182 can have the smallest cross-sectional area of the nozzle 152 and the fourth section 182 can have a low rate of change in cross-sectional area, the air stream can have the highest velocity through the nozzle 152 while flowing through the fourth section 182. In examples, the channel 166 within the fourth section 182 can include smooth surfaces to further limit turbulence and reduce the Reynolds number of the air stream through the nozzle 152. The nozzle 152 can be optimized to increase the velocity of air at the outlet 174 of the nozzle 152. Thus, the nozzle 152 can be configured to increase the velocity of the air stream at the outlet 118 of the housing 110. Here, the air stream can have a velocity of 1 to 20 m/s. More specifically, the air stream can have a velocity of 1 to 15 m/s. Even more specifically, the air stream can have a velocity of 1 to 10 m/s. For example, the air stream can have a velocity between 6 to 8 m/s.

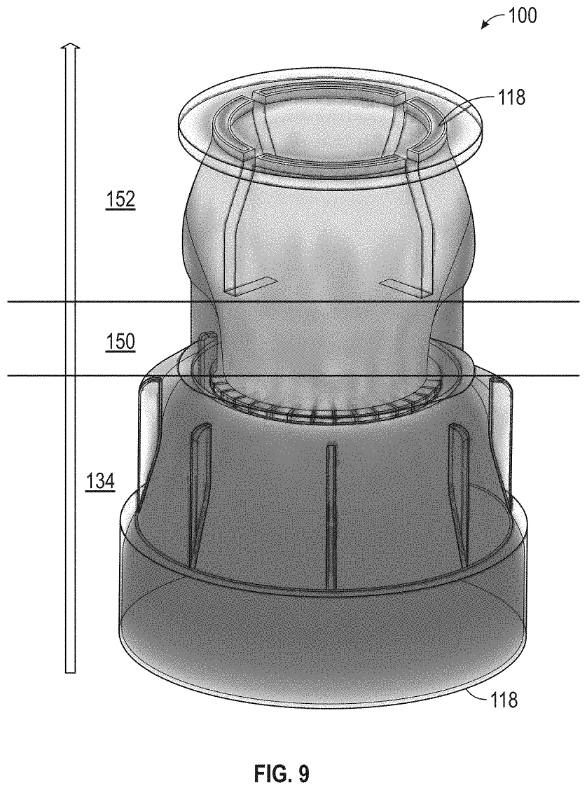

FIG. 9 illustrates an example of computational fluid dynamics (CFD) analysis of an air stream within the channel 166 through an example of the fan system 100 flowing from the inlet 116 to the outlet 118 of the housing 110 (first shown in FIG. 1). As shown in FIG. 9, the fan system 100 can be designed such that the velocity of the air stream flowing through the housing 110 has the lowest velocity at the inlet 116 of the housing 110. Moreover, the fan system 100 can be designed such that the velocity of the air stream flowing through the housing 110 has the highest velocity at the outlet 118 of the housing 110. In examples, the components of the fan system 100 within the housing 110 can be designed to decrease the Reynolds number throughout the housing 110 to reduce turbulent flow within the housing 110. In examples, the air stream flowing through the housing 110 can have an increased velocity as it flows out of the air filter 134 and into the fan 150. Moreover, the air stream flowing through the housing 110 can have an increased velocity as it flows out of the fan 150 as compared to before the fan 150. Here, the air stream straighteners (e.g., the airflow straighteners 164) help reduce the Reynolds number and reduce the eddy currents that would increase resistance of flow into the nozzle. The air stream flowing through the housing 110 can increase in velocity as it flows from the inlet 172 of the nozzle 152 to the outlet 174 of the nozzle 152. Here, the air stream within the housing 110 can have a maximum velocity at the outlet 174 of the nozzle 152.

FIG. 10 is a perspective view of a portion of the fan system 100 showing an example of a sensor 138. In an example, the sensor 138 can be mounted to the end cap 156 and the end cap 156 (shown in phantom) can include at least one aperture to enable the sensor 138 to communicate therethrough. Here, the sensor 138 can be removably attached to the end cap 156 with screws, clips, latches, or any other form of removable attachment. In another example, the sensor 138 can be integral to the end cap 156.

As discussed above, the fan system 100 can include the sensor cover 140 (shown in phantom). The sensor cover 140 can be transparent, translucent, or any other opacity that will enable the sensor 138 to communicate therethrough. The sensor cover 140 is configured to protect the sensor 138 and the end cap 156. Moreover, the sensor cover 140 can be configured to make the sensor 138 less noticeable within the housing 110. In the example shown in FIG. 10, the fan system 100 can include one of the sensor 138. In another example, the fan system 100 can include two or more of the sensor 138.

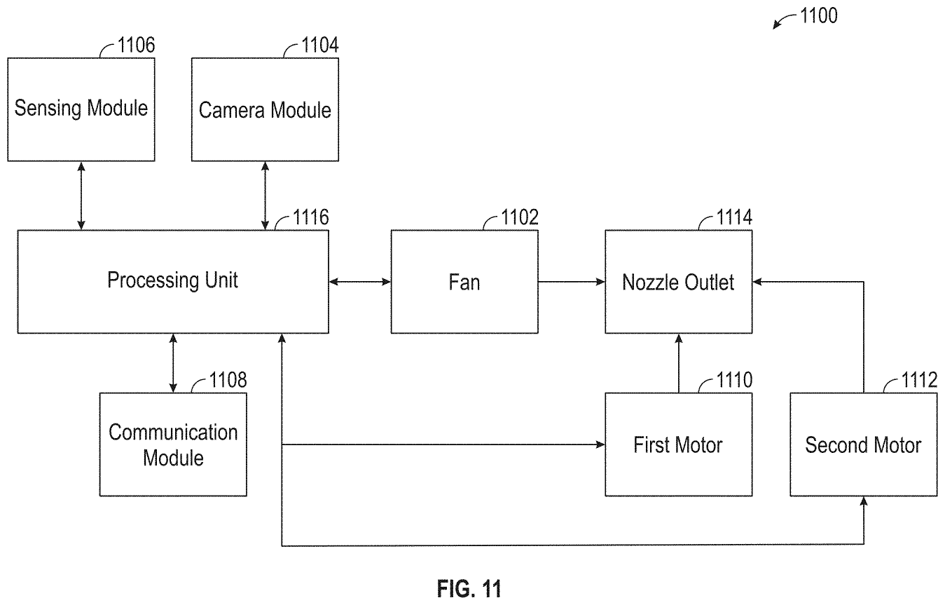

FIG. 11 is a schematic diagram of an example of the fan system 1100. A fan 1102 can be in fluidic communication with a nozzle outlet 1114 and in electrical communication with a processing unit 1116, A camera module 1104 can be in electrical communication with the processing unit 1116. Here, the processing unit 1116 can send a signal to the fan 1102 to control the speed at which the fan 1102 operates, and the fan 1102 generates an air stream within the fan system 1100 that that can be communicated to the nozzle outlet 1114. Thus, the signal sent from the processing unit 1116 to the fan 1102 defines how the fan 1102 communicates with the nozzle outlet 1114.

A sensing module 1106 can be in electrical communication with the processing unit 1116. In examples, the sensing module 1106 can include a MEMs accelerometer or gyroscope, a piezoelectric sensor, a proximity sensor, or any other kind of sensor that can detect the position of the fan system 1100. In examples, the processing unit 1116 can receive a signal from the sensing module 1106 and use that signal to compute changes that are necessary to maintain the desired air stream of the fan system 1100. In examples, the sensing module 1106 can detect a position, or a change of position, of the fan system 1100 and send a signal to the processing unit 1116. In another example the sensing module 1106 can include an air quality sensor to detect the air quality within the environment that the fan system 1100 is operating.

In another example, the sensing module 1106 can include a microphone to detect noises, for example, voice commands to control the fan system 1200. Here, the noises detected by the sensing module 1106 can help the processing unit 1116 determine the activities that the target is doing to help control the air stream to the target. In examples, in examples, the fan system 1100 can recognize predefined commands, e.g., human gestures or speech signals, and change its settings or operating mode based on those commands. These gestures can be defined as factory defaults, users of the system, or others with access to the system. For example, a user can gesture to the fan system 1100 or send a verbal request to increase the fan speed. The sensing module 1106 can detect these requests and send a signal to the processing unit 1116. The processing unit 1116 can change one or more operations (e.g., orientation or fan speed) of the fan system 1100 in response to the signal received from the sensing module 1106.

For example, if the target is exercising, heavy breathing or music can be indicative of such exercise and the processing unit 1116 can increase a volume or velocity of air sent to the target. In yet another example, the sensing module 1106 can include a temperature gauge to sense the temperature of the room that the fan system 1100 is operating within. The processing unit 1116 can use the temperature to increase or decrease the velocity of the air stream directed to the target. In yet another example, the temperature detected can also be a part of an alarm sequence to detect a fire or other hazardous condition that can help turn off the fan system 1200.

A communication module 1108 can be in communication with the processing unit 1116. In examples, the communication module 1108 can communicate to a cloud server, a personal electronic device, a configured remote controller, or any other device that is able to communicate to control the fan system 1100. The communication module 1108 can receive instructions for operation or updates for the software or firmware of the fan system 1100 and communicate those instructions and updates to the processing unit 1116.

The processing unit 1116 can also be in communication with a first motor 1110 and a second motor 1112. The first motor 1110 and the second motor 1112 can be operable to direct the fan system 1100 at a target (e.g., the motor 130 first shown in FIG. 1). The first motor 1110 and the second motor 1112 can each be in communication with the nozzle outlet 1114 because the first motor 1110 and the second motor 1112 can be operable to change the direction that the nozzle outlet 1114 is pointing, such as to direct an air stream to a target.

The processing unit 1116 can be configured to receive information from the fan 1102, the camera module 1104, the sensing module 1106, the communication module 1108, the first motor 1110, and the second motor 1112 and can be configured to process that information and send controlling signals to the fan 1102, the camera module 1104, the sensing module 1106, the communication module 1108, the first motor 1110, or the second motor 1112. In examples, the processing unit 1116 can send the collected information to the communication module 1108 to communicate the information with a cloud server with higher computing capacity (e.g., a neural network).

In examples, the fan system 1100 can capture digital images using the camera module 1104. The captured digital images can be stored in numerical arrays by the processing unit 1116. In examples, the processing unit 1116 can manipulate the stored numerical arrays. For example, a series of mathematical operations, including additions, convolutions, and other filters, can be applied to the numerical arrays to extract information about the scene (scene information). The processing unit 1116 can send the images to one or multiple convolutional neural networks through the communication module 1108. The output of this processing step can include, among other things, (i) a number of bounding boxes or image masks indicating the location of objects of interest, including living objects and partial objects, such as specific body parts; (ii) an estimate of the distance between the camera and each of these objects; (iii) a unique ID for each object; (iv) an aggregate of image features describing the visual appearance of each object that can be used to re-identify said object. The processing unit 1116 can use the image features of each object to re-identify them in subsequent images and record and track their location, velocity, and acceleration across subsequent images or time. The processing unit 1116 can also record the time-dependent evolution of the neural network outputs.

In one example, the images captured by the fan system 1100 can be processed by one single convolutional neural network (CNN) that returns one or all of the following for each object of interest: object location (e.g., bounding box), distance to the object, object pose, visual features that enable (re)-identification of the object. For example, the fan system 1100 can rely on a single CNN to detect humans, extract image features for each human that enable tracking and recognition of each human through time, or extract human poses (e.g., joints or gestures). In another example, the fan system 1100 can rely on a single CNN to detect humans, extract image features for each human that enable tracking and recognition of each human through time, extract human poses (e.g., joints or gestures), and infer human activity. In yet another example, the fan system 1100 can communicate with multiple CNN to complete analysis and help the fan system 1100 direct an air stream at the target.

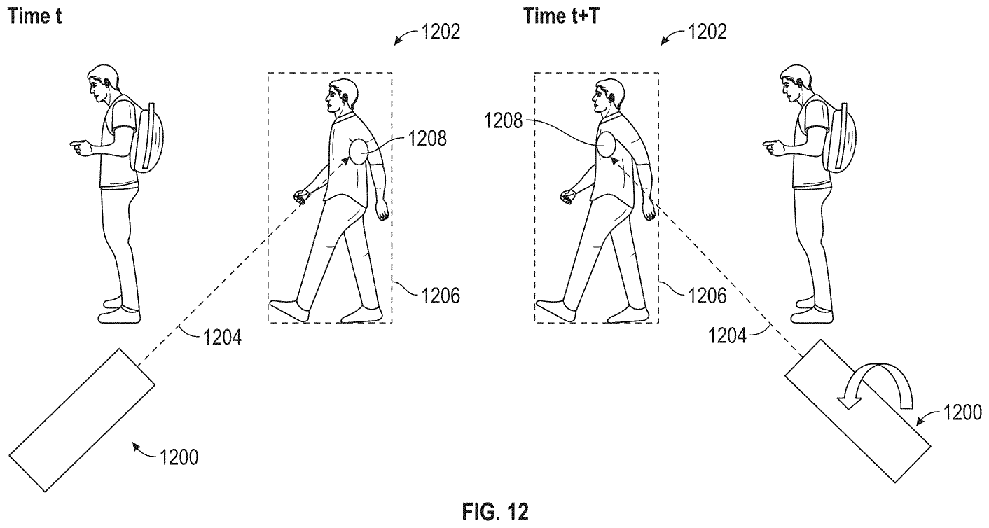

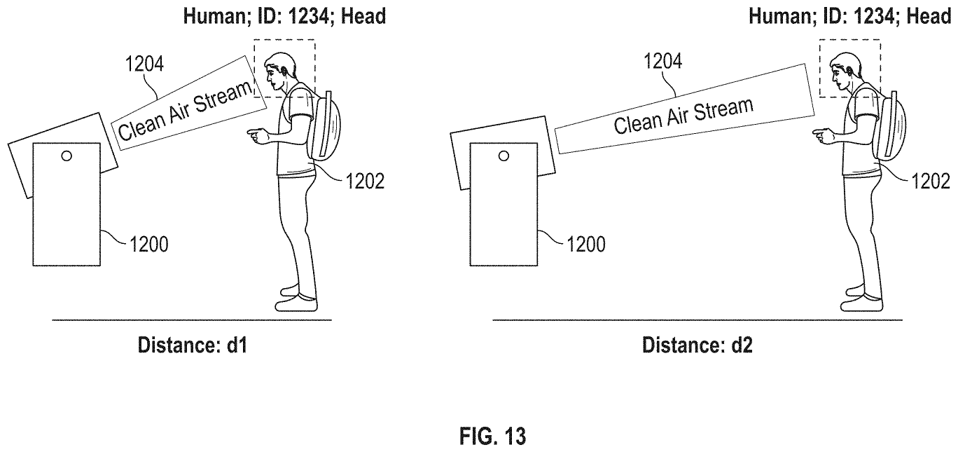

FIG. 12 illustrates an example of a fan system 1200 tracking a target 1202 in an environment. FIG. 13 illustrates an example of the fan system 1200 tracking the target 1202 in another environment. As shown in :FIG. 12, the fan system 1200 can identify and track the target 1202 over time while adjusting a fan speed and direction of an air stream 1204 to target the target 1202, For example, the fan system 1200 can use an array of numbers describing the coordinates of a bounding boxes 1206 or a characteristic marker 1208 around or in objects of interest. The target 1202 can be living objects (e.g., a person, pet, plant, or any other living organism) or inanimate objects, which can be well distinguished from their environment. The fan system 1200 can include a processing unit that can find the target 1202 and generate bounding box 1206 or the characteristic markers 1208 to gather information to control the fan system 1200. For example, the processor can use the information gathered to control a first motor or a second motor of the fan system 100 to change the direction of the air stream 1204 to track movements of the target 1202. For example, the controller can send an operable signal to the first or second motor to verify that the air stream 1204 is directed towards the target 1202, which is tracked with the bounding box 1206 or indicated by a segmentation mask. In another example, the processing unit can be configured so that the characteristic marker 1208 within the bounding box 1206 is the target 1202 and the fan system 1200 directs the air stream 1204 at the characteristic marker 1208.

As shown in FIG. 12, the fan system 1200 can adjust for changes of position of the target 1202. In examples, if the fan system 1200 detects changes of the location of the target after a certain time T, the processing unit can send operable signals to the motors to keep the air stream 1204 pointed onto the target 1202. The processing unit can also be configured to recognize the relative distance of the target object from the system by computing the sizes and distances of the boxes or markers. In another example, the processor of the fan system 1200 can also send an operable signal to a fan of the fan system 1200 to control the velocity of the air stream 1204 within the fan system 1200 and alter the distance the air stream 1204 is projected from the fan system 1200. For example, the processor can adjust the distance the air stream 1204 is projected from the fan system 1200 based on a calculated distance of the target from the system.

In yet another example, the fan system 1200 can also be configured to distinguish the target objected from other similar objects even if the object overlaps or intersects with other objects in the field of view of the camera. Here, the processing unit can use unique markers on the object or previous bounding box information to follow the target. In such an example, the fan system 1200 can identify and track the target 1202 to provide the air stream 1204 to the target 1202 in a crowded room.

As discussed above with reference to FIG. 11, the processing unit can identify the target 1202 and generate an ID for the target 1202. Moreover, the processing unit can detect a distance between the fan system 1200 and the target 1202 to determine if any adjustments are needed to maintain the air stream on the target 1202.

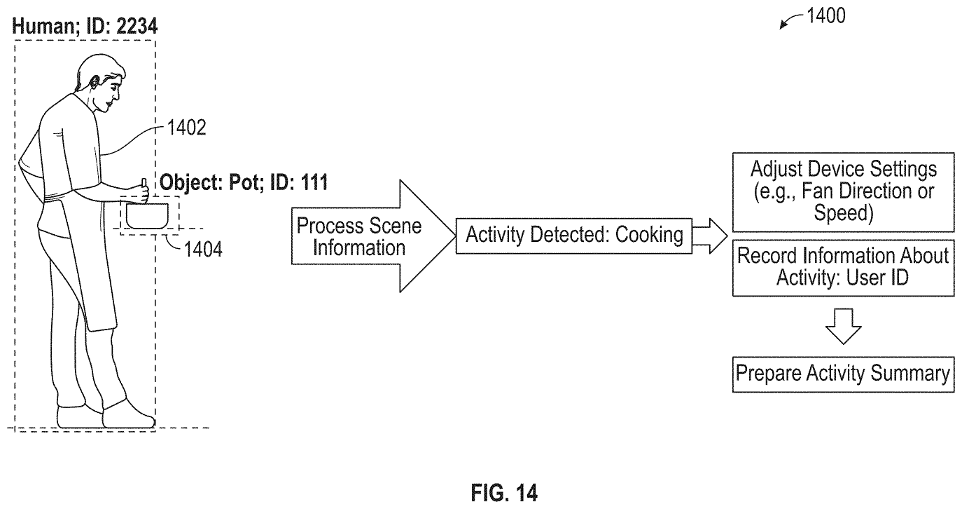

FIG. 14 illustrates an example of a fan system 1400 analyzing an activity 1404 of a target 1402. The fan system 1400 can use a processing unit to infer certain types of activities from information obtained through the camera module or the sensor module. The fan system 1400 can adjust operations (e.g., fan speed) based on this information reactively or in anticipation of additional activity. The fan system 1400 can record details about certain activities, such as when they occur, or at what frequency. For example, the fan system 1400 can recognize that the activity 1404 that the target 1402 is doing is push-ups, count the number of push-ups, and adjust the fan speed or direction for the time the target 1402 is doing push-ups. Similarly, the fan system 1400 can detect that the activity 1404 that the target 1402 is doing is cooking and adjust the fan speed or the direction of the air stream. The fan system 1400 can extract the poses of one or more of the target 1402. This information can be combined with other image or sensor data to facilitate the detection of certain user activities or hazardous situations.

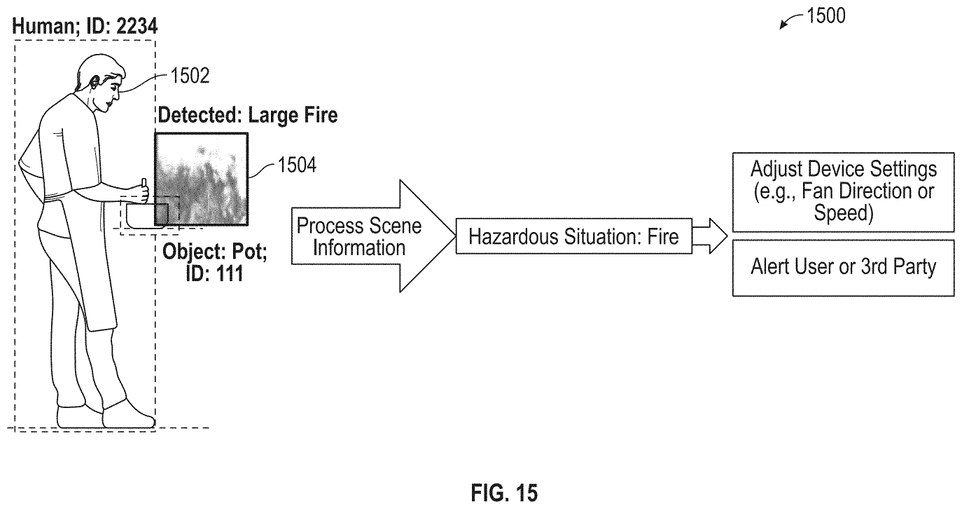

FIG. 15 illustrates an example of a fan system 1500 configured to analyze an activity 1504 of a target 1502. In examples, the fan system 1500 can use the information inferred from the data collected with the camera or the sensor module to detect hazardous situations. For example, the fan system 1500 can infer that the target 1502 has fallen, a fire is present, or that there is extensive smoke within the vicinity of the target 1502. The fan system 1500 can alert the user or third parties of such hazardous situations.

In examples, the fan system 1500 can store historic data relating to, among other things, scene information, image features, or sensor recordings. The fan system 1500 can use the stored historic data to learn and correlate image features, time, or sensor values with (a) The target 1502 preferred air stream settings or (b) air pollution patterns. Here, the fan system 1500 can proactively increase the fan speed when certain activities, e.g., cooking, are detected.

In another example, the fan system 1500 can prepare an aggregation of information about the activity 1504 of the target 1502 over several hours, days, weeks, or years. The fan system 1500 can then send the aggregated information to the user through any of a number of software platforms, such as via a mobile or web application. For example, the fan system 1500 can inform the target 1502 about the time they spent cooking, working, cleaning, or exercising in the past week.

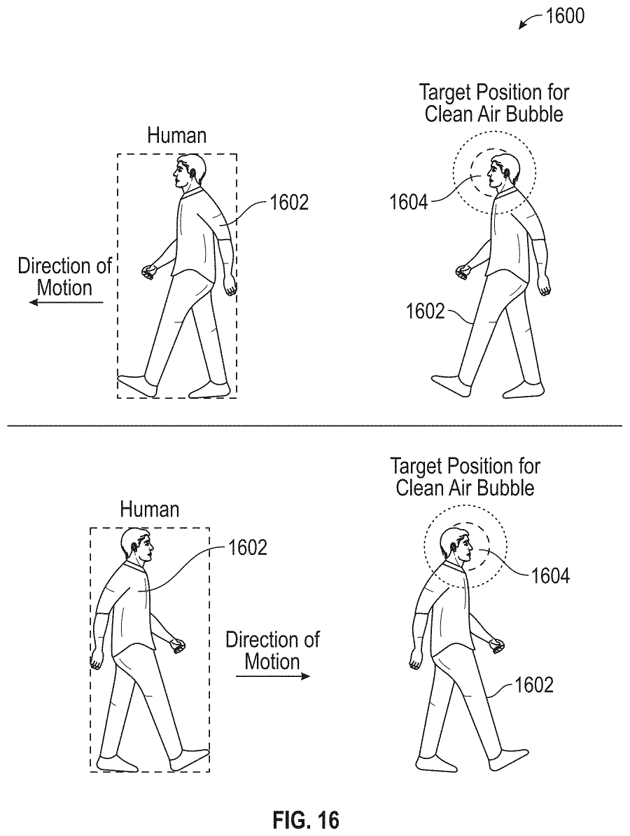

FIG. 16 illustrates an example of a fan system 1600 adjusting a bubble of clean air 1604 as a target 1602 moves in different directions. The fan system 1600 can synthesize scene information, including, for example, the target 1602 position and pose, activities detected, or potentially human trajectories, to determine where the bubble of clean air 1604 should be created at the current time and predict where to move the bubble of clean air 1604 in future time points. The fan system 1600 can also adjust the fan settings, including its direction, such that the clean air 1604 creates a region or volume of clean air at the position of the target 1602. For example, the region or volume of the bubble of clean air 1604 can be a function of the position of the target 1602, the orientation of the target 1602, and the direction or speed the target 1602 is moving. The fan system 1600 can direct the bubble of clean air 1604 at a set region or volume to manage the air surrounding the target 1602.

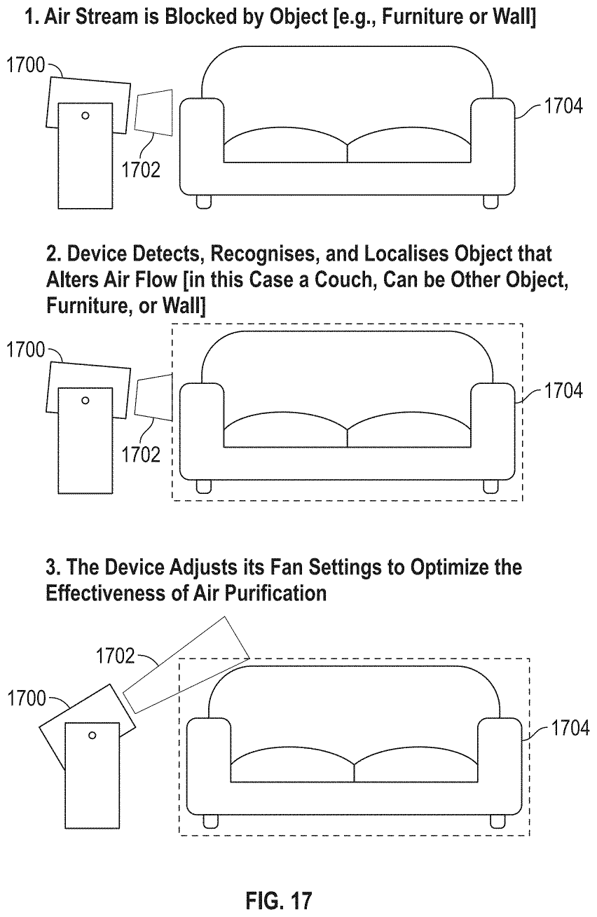

FIG. 17 illustrates an example of a fan system 1700 adjusting a direction of an air stream 1702 around an object 1704 obstructing the air stream 1702. The fan system 1700 can detect and localize the object 1704. In examples, the object 1704 can be any object that obstruct the air stream 1702, such as furniture, walls, open or dosed windows, and open or closed doors. The fan system 1700 can also estimate the size of a room in which it is positioned. The fan system 1700 can use the estimate of room size or the position of object 1704 to apply the preferred or optimal fan settings, including fan power and orientation, to purify a room's air as effectively as possible.

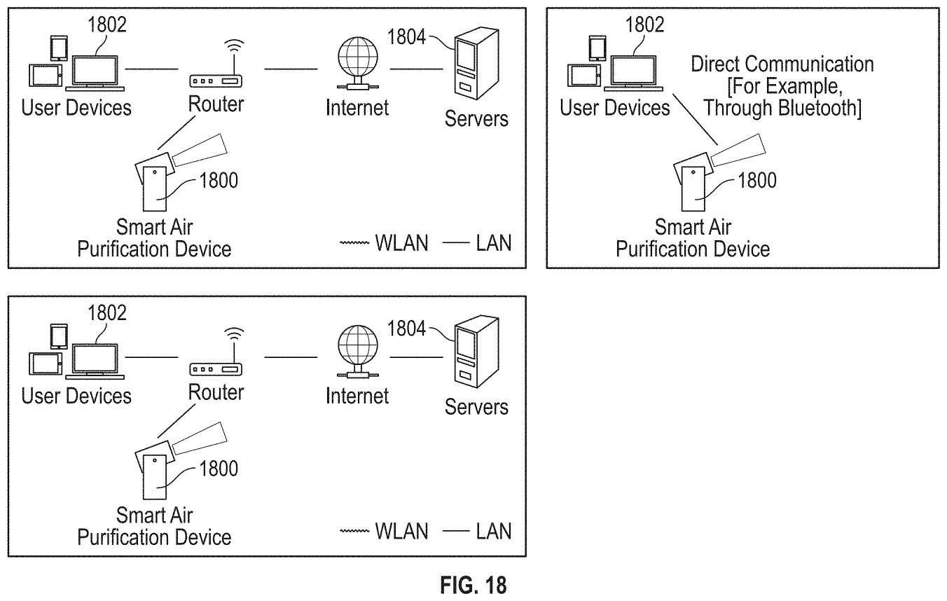

FIG. 18 is a schematic diagram showing data transfer between an example of a fan system 1800, a user device 1802, and a server 1804. In examples, the fan system 1800 can connect to one or more of the user device 1802 or to one or more of the server 1804 through a communication module. The communication module can be configured to relay information to or receive updates from a central server unit or other remote or off system controlling logic. The updates can include, among other things, changes to the device software, firmware, algorithms, or weights of the neural networks deployed on the fan system 1800. In examples, the fan system 1800 can transfer information recorded by the fan system 1800 to central servers (e.g., the server 1804) or other user devices (e.g., the user device 1802) for storage or further processing. The fan system 1800 can receive results of this additional processing from the servers or the other user devices. The fan system 1800 can connect to hand-held user devices over local connection methods (e.g., USB, or Bluetooth) or the internet to relay information to the user about certain activities conducted by the user. For example, the fan system 1800 can send results including a count of sit-ups, push-ups, squats, or other strength exercises, or advising on potential improvements in posture during exercising or daily living. Furthermore, a user can use a hand-held device or an interface on the system to select various operating modes.

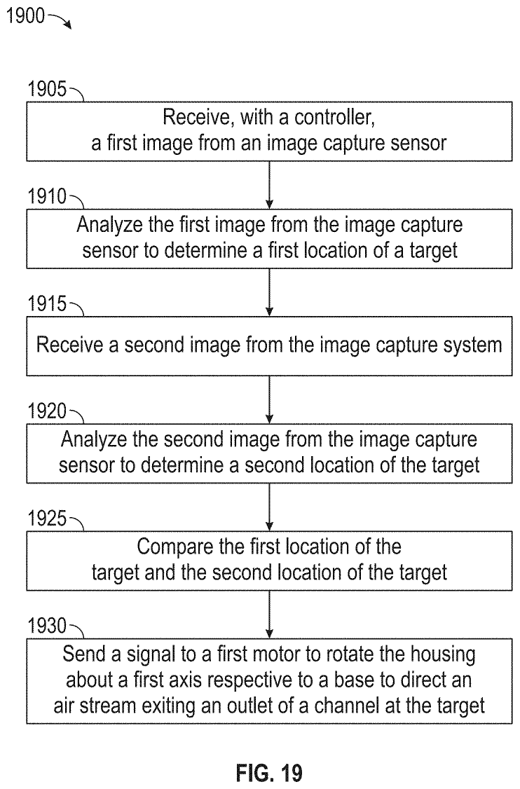

FIG. 19 illustrates a schematic view of the method 1900, in accordance with at least one example of this disclosure. The method 1900 can be a method of directing an air stream at a target. More specific examples of the method 1900 are discussed below. The steps or operations of the method 1900 are illustrated in a particular order for convenience and clarity; many of the discussed operations can be performed in a different sequence or in parallel without materially impacting other operations. The method 1900 as discussed includes operations performed by multiple different actors, devices, or systems. It is understood that subsets of the operations discussed in the method 1900 can be attributable to a single actor, device, or system could be considered a separate standalone process or method.

At operation 1905, the method 1900 can include receiving, with a controller, a first image from an image capture sensor. In examples, the first image can be a still image, or a motion image, in color, or in greyscale. The controller can receive the image and store the image for later reference.

At operation 1910, the method 1900 can include analyzing the first image from the image capture sensor to determine a first location of the target. In examples, the controller can complete the calculations to determine the location of the target. In another example, the controller can communicate via a communication module to a cloud server (e.g., a convolutional neural network “CNN”), such that the CNN can calculate the first location of the target and communicate the position of the target back to the controller.

At operation 1915, the method 1900 can include receiving a second image from the image capture system. In examples, the second image can be a still image, or a motion image, in color, or in greyscale. The controller can receive the second image and store the image for later reference.

At operation 1920, the method 1900 can include analyzing the second image from the image sensor to determine a second location of the target. In examples, the controller can complete the calculations to determine the location of the target. In another example, the controller can communicate via a communication module to a cloud server (e.g., a convolutional neural network “CNN”), such that the CNN can calculate the first location of the target and communicate the position of the target back to the controller

At operation 1925, the method 1900 can include comparing the first location of the target to the second location of the target. In examples, the controller or the CNN can use algorithms to compare the first location from the first image to the second location from the second image. In another example, the controller, or cloud server, can compare any other characteristic of the first image to any other characteristic of the second image. For example, the controller can compare a clarity, a distance, a time, or any other characteristic that can help the system direct an air stream at the target.

At operation 1930, the method 1900 can include sending a signal to a first motor to rotate a housing about a first axis respective to a base to direct an air stream exiting an outlet of a channel at the target. In examples, the signal sent from the controller is indicative of the change in location, or any other image characteristic, calculated between the first image and the second image.

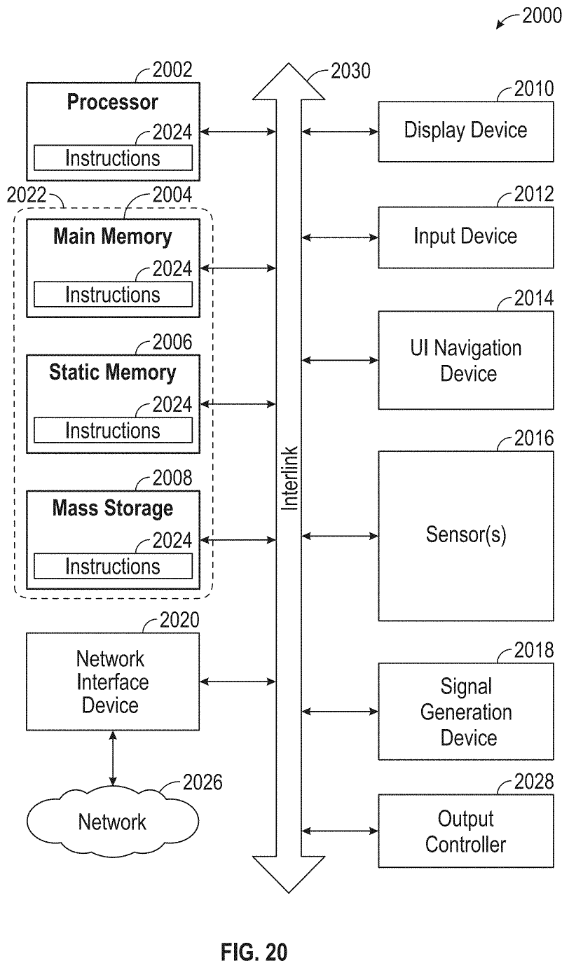

FIG. 20 illustrates a block diagram of an example machine 2000 upon which any one or more of the techniques (e.g., methodologies) discussed herein can perform. Examples, as described herein, can include, or can operate by, logic or a number of components, or mechanisms in the machine 2000. Circuitry (e.g., processing circuitry) is a collection of circuits implemented in tangible entities of the machine 2000 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 2000 follow.

In alternative examples, the machine 2000 can operate as a standalone device or can be connected (e.g., networked) to other machines. In a networked deployment, the machine 2000 can operate in the capacity of a server machine, a client machine, or both in server-client network environments. In an example, the machine 2000 can act as a peer machine in peer-to-peer (P2P) (or other distributed) network environment. The machine 2000 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 2000 can include a hardware processor 2002 (e.g., a central processing unit (CPU), a graphics processing unit (GPU), a hardware processor core, or any combination thereof), a main memory 2004, a static memory (e.g., memory or storage for firmware, microcode, a basic-input-output (BIOS), unified extensible firmware interface (UEFI), etc.) 2006, and mass storage 2008 (e.g., hard drives, tape drives, flash storage, or other block devices) some or all of which can communicate with each other via an interlink (e.g., bus) 2030. The machine 2000 can further include a display unit 2010, an alphanumeric input device 2012 (e.g., a keyboard), and a user interface (Up navigation device 2014 (e.g., a mouse). In an example, the display unit 2010, input device 2012 and UI navigation device 2014 can be a touch screen display. The machine 2000 can additionally include a storage device (e.g., drive unit) 2008, a signal generation device 2018 (e.g., a speaker), a network interface device 2020, and one or more sensors 2016, such as a global positioning system (GPS) sensor, compass, accelerometer, or other sensor. The machine 2000 can include an output controller 2028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 2002, the main memory 2004, the static memory 2006, or the mass storage 2008 can be, or include, a machine readable medium 2022 on which is stored one or more sets of data structures or instructions 2024 (e.g., software) embodying or utilized by any one or more of the techniques or functions described herein. The instructions 2024 can also reside, completely or at least partially, within any of registers of the processor 2002, the main memory 2004, the static memory 2006. or the mass storage 2008 during execution thereof by the machine 2000. In an example, one or any combination of the hardware processor 2002, the main memory 2004, the static memory 2006, or the mass storage 2008 can constitute the machine readable media 2022. While the machine readable medium 2022 is illustrated as a single medium, the term “machine readable medium” can include a single medium or multiple media a centralized or distributed database, and/or associated caches and servers) configured to store the one or more instructions 2024.

The term “machine readable medium” can include any medium that is capable of storing, encoding, or carrying instructions for execution by the machine 2000 and that cause the machine 2000 to perform any one or more of the techniques of the present disclosure, or that is capable of storing, encoding or carrying data structures used by or associated with such instructions. Non-limiting machine readable medium examples can include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 2022 can be representative of the instructions 2024, such as instructions 2024 themselves or a format from which the instructions 2024 can be derived. This format from which the instructions 2024 can be derived can include source code, encoded instructions (e.g., in compressed or encrypted form), packaged instructions (e.g., split into multiple packages), or the like. The information representative of the instructions 2024 in the machine readable medium 2022 can be processed by processing circuitry into the instructions to implement any of the operations discussed herein. For example, deriving the instructions 2024 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 2024.

In an example, the derivation of the instructions 2024 can include assembly, compilation, or interpretation of the information (e.g., by the processing circuitry) to create the instructions 2024 from some intermediate or preprocessed format provided by the machine readable medium 2022. The information, when provided in multiple parts, can be combined, unpacked, and modified to create the instructions 2024. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 2024 can be further transmitted or received over a communications network 2026 using a transmission medium via the network interface device 2020 utilizing any one of a number of transfer protocols (e.g., frame relay, interne protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 2020 can include one or more physical jacks (e.g., Ethernet, coaxial, or phone jacks) or one or more antennas to connect to the communications network 2026. In an example, the network interface device 2020 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 2000, and includes digital or analog communications signals or other intangible medium to facilitate communication of such software. A transmission medium is a machine readable medium.

### Additional Notes & Examples

Example 1 is a fan system for directing an air stream at a target, the fan system comprising: a base configured to rest on a surface of an environment; an arm including a first portion rotatably connected to the base and including a second portion opposite the first portion; a housing rotatably attached to the second portion of the arm, the housing defining a channel extending between an inlet and an outlet; a first motor connected to the first portion of the arm and the base and operable to rotate the arm and the housing about a first axis relative to the base; a second motor connected to the second portion and the housing and operable to rotate the housing about a second axis relative to the base; a fan located within the housing between the inlet and the outlet of the channel, the fan operable to generate an air stream to flow through the channel from the inlet to the outlet; an image capture sensor connected to the housing and configured to produce an image capture signal based on images of the environment; and a controller in communication with the first motor, the second motor, the fan, and the image capture sensor, the controller configured to control the fan, the first motor, and the second motor based on the image capture signal.

In Example 2, the subject matter of Example 1 includes, a nozzle located within the housing between the outlet of the channel and the fan, the nozzle defining at least a portion of the channel.

In Example 3, the subject matter of Example 2 includes, wherein the nozzle is configured to reduce turbulence in the air stream discharged from the outlet of the channel.

In Example 4, the subject matter of Example 3 includes, wherein the nozzle at least partially defines the outlet and wherein the outlet has the shape of a ring.

In Example 5, the subject matter of Example 4 includes, wherein the image capture sensor is located within the ring and out of the air stream.

In Example 6, the subject matter of Examples 4-5 includes, a transparent cover plate secured to the nozzle to enclose the image capture sensor.

In Example 7, the subject matter of Examples 1-6 includes, wherein the controller further comprises: a memory including instructions; and processing circuitry that, when in operation, is configured by the instructions to: receive a first image from the image capture sensor; analyze the first image from the image capture sensor to determine a first location of the target; receive a second image from the image capture sensor; analyze the second image from the image capture sensor to determine a second location of the target; compare the first location of the target and the second location of the target; and send a signal to the first motor and to the second motor to reposition the housing to direct the air stream exiting the outlet of the channel at the target.

In Example 8, the subject matter of Example 7 includes, wherein the memory includes reference images, and wherein the reference images are images of scenarios that indicate or instruct deviations from standard operation of the fan system.

In Example 9, the subject matter of Example 8 includes, wherein the instructions configure the processing circuitry to: compare images from the image capture sensor to the reference images; detect whether a fire is present in the images from the image capture sensor; and shut off the fan system when the fire is present.

In Example 10, the subject matter of Examples 8-9 includes, wherein the instructions configure the processing circuitry to: compare images from the image capture sensor to the reference images; detect the target is cooking in the images from the image capture sensor; and increase the velocity of the air stream from the outlet of the channel to increase an amount of air sent toward the target.

In Example 11, the subject matter of Examples 810 includes, wherein the instructions configure the processing circuitry to: compare images from the image capture sensor to the reference images; detect the target is exercising in the images from the image capture sensor; and increase the velocity of the air stream from the outlet of the channel in the direction of the target.

Example 12 is a fan system for directing an air stream at a target, the fan system comprising: a base configured to rest on a surface of an environment; an arm including a first portion rotatably connected to the base and including a second portion opposite the first portion; a housing rotatably attached to the second portion of the arm, the housing defining a channel extending between an inlet and an outlet; a first motor connected to the first portion of the arm and the base and operable to rotate the arm and the housing about a first axis relative to the base; a fan located within the housing between the inlet and the outlet of the channel, the fan operable to generate an air stream to flow through the channel from the inlet to the outlet; a sensor connected to the housing and configured to produce a signal based on the environment; and a controller in communication with the first motor, the fan, and the sensor, the controller configured to control the fan and the first motor based on the signal.

In Example 13, the subject matter of Example 12 includes, a nozzle located within the housing between the outlet of the channel and the fan, the nozzle defining at least a portion of the channel.

In Example 14, the subject matter of Example 13 includes, wherein the nozzle is configured to reduce turbulence flow in the air stream discharged from the outlet of channel.

In Example 15, the subject matter of Example 14 includes, wherein the nozzle at least partially defines the outlet and wherein the outlet has the shape of a ring.

In Example 16, the subject matter of Example 15 includes, wherein the sensor is a image sensor, and wherein the image sensor is located within the ring and out of the air stream.

In Example 17, the subject matter of Examples 12-16 includes, a radial filter between the inlet of the channel and the fan.

Example 18 is a method of a fan system directing an air stream at a target, the fan system including a base, an arm including a first portion rotatably connected to the base and including a second portion opposite the first portion, and a housing rotatably attached to the second portion of the arm, the housing including an image capture sensor and defining a channel extending between an inlet and an outlet, the method comprising: receiving, with a controller, a first image from the image capture sensor; analyzing the first image from the image capture sensor to determine a first location of the target; receiving a second image from the image capture sensor; analyzing the second image from the image capture sensor to determine a second location of the target; comparing the first location of the target and the second location of the target; and sending a signal to a first motor to rotate the housing about a first axis respective to a base to direct an air stream exiting the outlet of the channel at the target.

In Example 19, the subject matter of Example 18 includes, sending a signal to a second motor to rotate the housing about a second axis respective the second portion of the arm.

In Example 20, the subject matter of Example 19 includes, wherein the controller includes a memory having reference images stored thereon, the reference images are images of scenarios that indicate or instruct deviations from standard operation of the fan system, the method further comprising: comparing images from the image capture sensor to the reference images; determining an object is preventing the air stream from reaching the target; and sending a signal to the first motor and to the second motor to reposition the housing to direct the air stream exiting the outlet of the channel away from the object and toward the target.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description includes references to the accompanying drawings, which form a part of the detailed description. The drawings show, by way of illustration, specific embodiments that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described. examples (or one or more aspects thereof) can be used in combination with each other. Other embodiments can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the embodiments should be determined with reference to the appended claims, along with the flan scope of equivalents to which such claims are entitled.

1. A fan system for directing an air stream at a target, the fan system comprising:
a base configured to rest on a surface of an environment;
an arm including a first portion rotatably connected to the base and including a second portion opposite the first portion;
a housing rotatably attached to the second portion of the arm, the housing defining a channel extending between an inlet and an outlet;
a first motor connected to the first portion of the arm and the base and operable to rotate the arm and the housing about a first axis relative to the base:
a second motor connected to the second portion and the housing and operable to rotate the housing about a second axis relative to the base;
a fan located within the housing between the inlet and the outlet of the channel, the fan operable to generate an air stream to flow through the channel from the inlet to the outlet;
an image capture sensor connected to the housing and configured to produce an image capture signal based on images of the environment; and
a controller in communication with the first motor, the second motor, the fan, and the image capture sensor, the controller configured to control the fan, the first motor, and the second motor based on the image capture signal.

2. The fan system of claim 1, further comprising:
a nozzle located within the housing between the outlet of the channel and the fan, the nozzle defining at least a portion of the channel.

3. The fan system of claim 2, wherein the nozzle is configured to reduce turbulence in the air stream discharged from the outlet of the channel.

4. The fan system of claim 3, wherein the nozzle at least partially defines the outlet and wherein the outlet has the shape of a ring.

5. The fan system of claim 4, wherein the image capture sensor is located within the ring and out of the air stream.

6. The fan system of claim 4, further comprising:
a transparent cover plate secured to the nozzle to enclose the image capture sensor.

7. The fan system of claim 1, wherein the controller further comprises:
a memory including instructions; and
processing circuitry that, when in operation, is configured by the instructions to:
receive a first image from the image capture sensor;
analyze the first image from the image capture sensor to determine a first location of the target;
receive a second image from the image capture sensor;
analyze the second image from the image capture sensor to determine a second location of the target;
compare the first location of the target and the second location of the target; and
send a signal to the first motor and to the second motor to reposition the housing to direct the air stream exiting the outlet of the channel at the target.

8. The fan system of claim 7, wherein the memory includes reference images, and wherein the reference images are images of scenarios that indicate or instruct deviations from standard operation of the fan system.

9. The fan system of claim 8, wherein the instructions configure the processing circuitry to:
compare images from the image capture sensor to the reference images;
detect whether a fire is present in the images from the image capture sensor; and
shut off the fan system when the fire is present.

10. The fan system of claim 8, wherein the instructions configure the processing circuitry to:
compare images from the image capture sensor to the reference images;
detect the target is cooking in the images from the image capture sensor; and
increase the velocity of the air stream from the outlet of the channel to increase an amount of air sent toward the target.

11. The fan system of claim 8, wherein the instructions configure the processing circuitry to:
compare images from the image capture sensor to the reference images;
detect the target is exercising in the images from the image capture sensor; and
increase the velocity of the air stream from the outlet of the channel in the direction of the target.

12. A fan system for directing an air stream at a target, the fan system comprising:
a base configured to rest on a surface of an environment;
an arm including a first portion rotatably connected to the base and including a second portion opposite the first portion;
a housing rotatably attached to the second portion of the arm, the housing defining a channel extending between an inlet and an outlet;
a first motor connected to the first portion of the arm and the base and operable to rotate the arm and the housing about a first axis relative to the base;
a fan located within the housing between the inlet and the outlet of the channel, the fan operable to generate an air stream to flow through the channel from the inlet to the outlet;
a sensor connected to the housing and configured to produce a signal based on the environment; and
a controller in communication with the first motor, the fan, and the sensor, the controller configured to control the fan and the first motor based on the signal.

13. The fan system of claim 12, further comprising:
a nozzle located within the housing between the outlet of the channel and the fan, the nozzle defining at least a portion of the channel.

14. The fan system of claim 13, wherein the nozzle is configured to reduce turbulence in the air stream discharged from the outlet of channel.

15. The fan system of claim 14, wherein the nozzle at least partially defines the outlet and wherein the outlet has the shape of a ring.

16. The fan system of claim 15, wherein the sensor is an image sensor, and wherein the image sensor is located within the ring and out of the air stream.

17. The fan system of claim 12, further comprising:
a radial filter between the inlet of the channel and the fan.

18. A method of a fan system directing an air stream at a target, the fan system including a base, an arm including a first portion rotatably connected to the base and including a second portion opposite the first portion, and a housing rotatably attached to the second portion of the arm, the housing including an image capture sensor and defining a channel extending between an inlet and an outlet, the method comprising:
receiving, with a controller, a first image from the image capture sensor;
analyzing the first image from the image capture sensor to determine a first location of the target;
receiving a second image from the image capture sensor;
analyzing the second image from the image capture sensor to determine a second location of the target;
comparing the first location of the target and the second location of the target; and
sending a signal to a first motor to rotate the housing about a first axis respective to a base to direct an air stream exiting the outlet of the channel at the target.

19. The method of claim 18, further comprising:
sending a signal to a second motor to rotate the housing about a second axis respective the second portion of the arm.

20. The method of claim 19, wherein the controller includes a memory having reference images stored thereon, the reference images are images of scenarios that indicate or instruct deviations from standard operation of the fan system, the method further comprising:
comparing images from the image capture sensor to the reference images;
determining an object is preventing the air stream from reaching the target; and
sending a signal to the first motor and to the second motor to reposition the housing to direct the air stream exiting the outlet of the channel away from the object and toward the target.
